(19) United States
(12) Patent Application Publication
(10) Pub. No.: US 2022/0163345 A1
(43) Pub. Date: May 26, 2022

(54) INFORMATION PROCESSING APPARATUS, INFORMATION PROCESSING METHOD, AND NON-TRANSITORY STORAGE MEDIUM

(71) Applicant: TOYOTA JIDOSHA KABUSHIKI KAISHA, Toyota-shi (JP)

(72) Inventors: Fumihiro NASU, Toyota-shi (JP); Shintaro MATSUTANI, Kariya-shi (JP); Kazuhito BABA, Nagoya-shi (JP); Shinichiro Futakuchi, Kasugai-shi (JP); Miku TANAKA, Nagoya-shi (JP)

(73) Assignee: TOYOTA JIDOSHA KABUSHIKI KAISHA, Toyota-shi (JP)

(21) Appl. No.: 17/523,104

(22) Filed: Nov. 10, 2021

(30) Foreign Application Priority Data
Nov. 20, 2020 (JP) 2020-193867

(51) Int. Cl. G01C 21/36; G06Q 20/32; G06Q 20/10

(52) U.S. Cl. CPC G01C 21/3697; G06Q 20/102; G06Q 20/3276; G01C 21/3679

(57) ABSTRACT

An information processing apparatus including a controller configured to perform: obtaining a current location of a user; obtaining a destination of the user; outputting guidance to the destination; obtaining information corresponding to the destination; determining, based on the destination and the current location, that the user has arrived at the destination; and switching from outputting the guidance to the destination to outputting the information corresponding to the destination, when the user has arrived at the destination.

### CROSS REFERENCE TO THE RELATED APPLICATION

This application claims the benefit of Japanese Patent Application No. 2020-193867, filed on Nov. 20, 2020, which is hereby incorporated by reference herein in its entirety.

### BACKGROUND

### Technical Field

The present disclosure relates to an information processing apparatus, an information processing method, and a non-transitory storage medium in which a program is stored.

### Description of the Related Art

In a navigation system, it is known that a destination is highlighted and displayed on a screen when the destination is approached (for example, Patent Literature 1).

### CITATION LIST

### Patent Literature

Patent Literature 1: Japanese Patent Application Laid-Open Publication No. 2015-068828

### SUMMARY

An object of the present disclosure is to provide appropriate information to a user after arrival at a destination.

One aspect of the present disclosure is directed to an information processing apparatus including a controller configured to perform;

obtaining a current location of a user;

obtaining a destination of the user;

outputting guidance to the destination;

obtaining information corresponding to the destination;

determining, based on the destination and the current location, that the user has arrived at the destination; and

switching from outputting the guidance to the destination to outputting the information corresponding to the destination, when the user has arrived at the destination.

Another aspect of the present disclosure is directed to an information processing method for causing a computer to perform:

obtaining a current location of a user;

obtaining a destination of the user;

outputting guidance to the destination;

obtaining information corresponding to the destination;

determining, based on the destination and the current location, that the user has arrived at the destination; and

switching from outputting the guidance to the destination to outputting the information corresponding to the destination, when the user has arrived at the destination.

In addition, a still further aspect of the present disclosure is directed to a program for causing a computer to perform the above-described method, or a storage medium storing the program in a non-transitory manner.

According to the present disclosure, it is possible to provide appropriate information to a user after arrival at a destination.

### BRIEF DESCRIPTION OF THE DRAWINGS

FIG. 1 is a view illustrating a schematic configuration of a system according to an embodiment;

FIG. 2 is a block diagram schematically illustrating an example of a configuration of each of an in-vehicle device, a user terminal and a center server; which together constitute the system according to the embodiment;

FIG. 3 is a diagram illustrating by way of example a functional configuration of the center server;

FIG. 4 is a view illustrating by way of example a table configuration of vehicle information;

FIG. 5 is a view illustrating by way of example a table configuration of provision information;

FIG. 6 is a view illustrating by way of example a functional configuration of the in-vehicle device;

FIG. 7 is a flowchart of provision processing according to the embodiment;

FIG. 8 is a flowchart of processing executed by the in-vehicle device according to the embodiment;

FIG. 9 is a view illustrating an example of an image displayed on a display of the in-vehicle device during route guidance;

FIG. 10 is a view illustrating an example of an image displayed on the display of the in-vehicle device when a vehicle arrives at a destination; and

FIG. 11 is a view illustrating an example of another image displayed on the display of the in-vehicle device when the vehicle arrives at the destination.

### DESCRIPTION OF THE EMBODIMENTS

A user is able to reach a destination by using a navigation system. However, the navigation system does not provide information about the destination. Therefore, without knowledge about the destination, the user needs to look up information about the destination by using a terminal or the like. In view of this, in the present disclosure, there is proposed a technique that allows a user to obtain information about a destination without having to look it up by himself or herself.

An information processing apparatus, which is one aspect of the present disclosure, includes a controller. The controller performs: obtaining a current location of a user; obtaining a destination of the user; outputting guidance to the destination; obtaining information corresponding to the destination; determining, based on the destination and the current location, that the user has arrived at the destination; and switching from outputting the guidance to the destination to outputting the information corresponding to the destination, when the user has arrived at the destination.

The current location of the user may be, for example, a current location of a terminal carried by the user or a current location of a vehicle or the like in which the user is riding. The current location of the user can be obtained by a sensor, for example. The destination of the user may be, for example, a destination entered by the user into the navigation system. In guiding the user to the destination, for example, a route may be generated according to a predetermined rule based on the current location and the destination of the user, so that the user may be guided to pass through the route. For example, the controller may determine that the user has arrived at the destination, when the current location matches the destination, or when the current location is within a predetermined distance from the destination. The predetermined distance is, for example, a distance at which the user can arrive at the destination even when the route guidance is terminated, or a distance at which the user can be said to be close to the destination to such an extent that guidance to the destination is not necessary.

The controller outputs guidance to the destination until the user arrives at the destination. By guiding the user to the destination, the user can arrive at the destination smoothly. In the guidance to the destination, for example, the route may be displayed on a display of a terminal carried by the user or a display of an in-vehicle device of the vehicle in which the user is riding. Further, when the user arrives at the destination, the controller switches from outputting guidance to the destination to outputting information corresponding to the destination. By this switching, the guidance to the destination is terminated, and the output of information corresponding to the destination is started. For example, applications may be switched before and after the user arrives at the destination.

The information corresponding to the destination is, for example, information about the services that the user will receive at the destination. Also, the information corresponding to the destination may be information related to the destination and useful to the user. For example, in cases where the destination is a tourist site, the information corresponding to the destination includes information about tourist guidance or tourist spots. In addition, for example, in cases where the destination is a drive-through of a restaurant, information about a menu of the restaurant is included in the information corresponding to the destination. Moreover, for example, in cases where the destination is a parking lot, the information corresponding to the destination includes information about a parking fee or information about stores or facilities that provide a discount service of the parking fee. In cases where the parking fee varies depending on the parking time or vehicle, the information corresponding to the destination includes information that can be used as a guide for the parking fee.

In addition, for example, in cases where the user needs to pay a fee at the destination, information for making a payment (e.g., information for displaying a payment screen or information for displaying a two-dimensional code for making a payment) is included in the information corresponding to the destination. The payment is, for example, payment of a parking fee in a parking lot, payment of food and drink in a restaurant, or payment of gasoline in a gas station. In addition, for example, in cases where the destination is a drive-through of a restaurant, the information corresponding to the destination may include both information about a menu and information for making a payment. When the destination is a train station, the information corresponding to the destination includes information about a time table of trains or information about transfer guidance.

In this way, by outputting the information corresponding to the destination, the user does not need to search for information about the destination by himself or herself. Therefore, the convenience of the user can be improved.

Hereinafter, embodiments of the present disclosure will be described based on the accompanying drawings. The configurations of the following embodiments are examples, and the present disclosure is not limited to the configurations of the embodiments. In addition, the following embodiments can be combined with one another as long as such combinations are possible and appropriate.

### First Embodiment

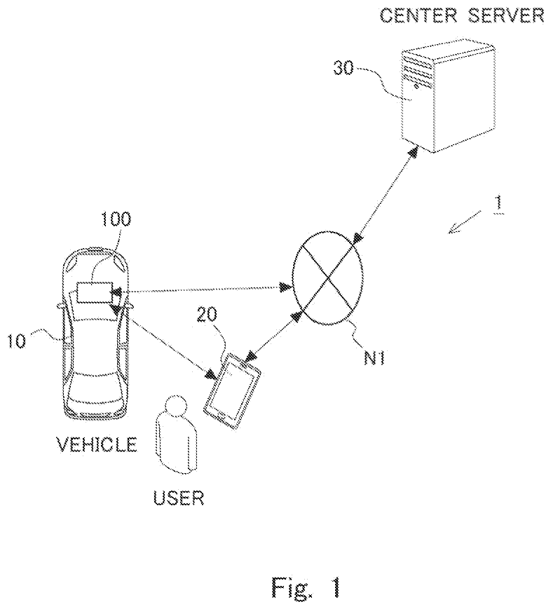

FIG. 1 is a view illustrating a schematic configuration of a system 1 according to a first embodiment. When a vehicle 10 in which a user is riding arrives at a destination, the system 1 causes an in-vehicle device 100 to display information according to the destination. The in-vehicle device 100 includes, for example, a navigation system. For example, in cases where the destination is a restaurant, the information to be displayed is a menu of the restaurant. The restaurant includes a drive-through. In addition, in cases where the destination is a parking lot, the information to be displayed is information about a parking fee or facilities or stores from which a discount of the parking fee can be received. Also, for example, in cases where the destination is a tourist site, the information to be displayed is a guide to tourist spots or a guide to tourist routes. In the present embodiment, these pieces of information are displayed on the in-vehicle device 100, but as an alternative method, they may be displayed on a user terminal 20. The user is a user who is riding in the vehicle 10. The user terminal 20 is a portable terminal that is carried by the user.

In the example of FIG. 1, the system 1 includes the in-vehicle device 100 mounted on the vehicle 10, the user terminal 20, and a server 30. The in-vehicle device 100, the user terminal 20, and the server 30 are connected to one another by means of a network N1. Note that the network N1 is, for example, a worldwide public network such as the Internet, and a WAN (Wide AREA Network) or other communication networks may be employed. Also, the network N1 may include a telephone communication network such as a mobile phone network or the like, and/or a wireless communication network such as Wi-Fi (registered trademark) or the like. In addition, the in-vehicle device 100 and the user terminal 20 may be connected to each other by short-range wireless communication such as Bluetooth (registered trademark) or the like. FIG. 1 illustrates one vehicle 10 by way of example, but there can be a plurality of vehicles 10. Further, there can also be a plurality of users and user terminals 20, depending on the number of vehicles 10.

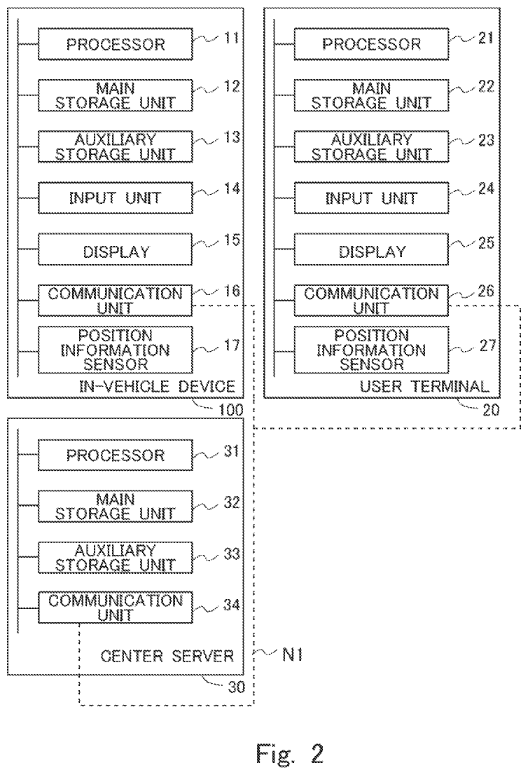

Hardware configurations and functional configurations of the in-vehicle device 100, the user terminal 20 and the center server 30 will be described based on FIG. 2. FIG. 2 is a block diagram schematically illustrating one example of the configuration of each of the in-vehicle device 100, the user terminal 20, and the center server 30, which together constitute the system 1 according to the present embodiment.

The center server 30 has a configuration of a general computer. The center server 30 includes a processor 31, a main storage unit 32, an auxiliary storage unit 33, and a communication unit 34. These components are connected to one another by means of a bus.

The processor 31 is a CPU (Central Processing Unit), a DSP (Digital Signal Processor), or the like. The processor 31 controls the center server 30 thereby to perform various information processing operations. The main storage unit 32 is a RAM (Random Access Memory), a ROM (Read Only Memory), or the like. The auxiliary storage unit 33 is an EPROM (Erasable Programmable ROM), a hard disk drive (HDD), a removable medium, or the like. The auxiliary storage unit 33 stores an operating system (OS), various programs, various tables, and the like. The processor 31 loads the programs stored in the auxiliary storage unit 33 into a work area of the main storage unit 32 and executes the programs, so that each of the component units or the like is controlled through the execution of the programs. Thus, the center server 30 realizes functions matching predetermined purposes, respectively. The main storage unit 32 and the auxiliary storage unit 33 are computer readable recording media. Here, note that the center server 30 may be a single computer or a plurality of computers that cooperate with one another. In addition, the information stored in the auxiliary storage unit 33 may be stored in the main storage unit 32. Also, the information stored in the main storage unit 32 may be stored in the auxiliary storage unit 33.

The communication unit 34 is a means or unit that communicates with the in-vehicle device 100 and the user terminal 20 via the network N1. The communication unit 34 is, for example, a LAN (Local Area Network) interface board or a wireless communication circuit for wireless communication. The LAN interface board and the wireless communication circuit are connected to the network N1.

Here, note that a series of processing executed by the center sever 30 can be executed by hardware, but can also be executed by software.

Next, the user terminal 20 will be described. The user terminal 20 is, for example, a smart phone, a mobile phone, a tablet terminal, a personal information terminal, a wearable computer (such as a smart watch or the like), or a small computer such as a personal computer (PC). The user terminal 20 includes a processor 21, a main storage unit 22, an auxiliary storage unit 23, an input unit 24, a display 25, a communication unit 26, and a position information sensor 27. These components are connected to one another by means of a bus. The processor 21, the main storage unit 22 and the auxiliary storage unit 23 are the same as the processor 31, the main storage unit 32 and the auxiliary storage unit 33 of the center server 30, respectively, and hence, the description thereof will be omitted.

The input unit 24 is a means or unit that receives an input operation performed by the user, and is, for example, a touch panel, a mouse, a keyboard, a push button, or the like. The display 25 is a means or unit that presents information to the user, and is, for example, an LCD (Liquid Crystal Display), an EL (Electroluminescence) panel, or the like. The input unit 24 and the display 25 may be configured as a single touch panel display.

The communication unit 26 is a communication means or unit for connecting the user terminal 20 to the network N1 The communication unit 26 is a circuit for communicating with other devices (e.g., the in-vehicle device 100, the center server 30 or the like) via the network N1 by making use of a mobile communication service (e.g., a telephone communication network such as 5G (5th Generation), 4G (4th Generation), 3G (3rd Generation), or LTE (Long Term Evolution)) or a wireless communication network such as Wi-Fi (registered trademark), Bluetooth (registered trademark) or the like.

The position information sensor 27 obtains position information (e.g., latitude and longitude) of the user terminal 20. The position information sensor 27 is, for example, a GPS (Global Positioning System) receiver unit, a wireless LAN communication unit, or the like.

Then, the in-vehicle device 100 of the vehicle 10 will be described. The in-vehicle device 100 may be fixed to the vehicle 10 or may be mounted thereon in a removable manner. For example, the in-vehicle device 100 guides the user along a moving route. The in-vehicle device 100 includes a processor 11, a main storage unit 12, an auxiliary storage unit 13, an input unit 14, a display 15, a communication unit 16, and a position information sensor 17. These components are connected to one another by means of a bus. The processor 11, the main storage unit 12, the auxiliary storage unit 13, the input unit 14, the display 15, and the communication unit 16 are the same as the processor 21, the main storage unit 22, the auxiliary storage unit 23, the input unit 24, the display 25, and the communication unit 26 of the user terminal 20, respectively, and hence, the description thereof will be omitted. Note that the processor 11 is an example of a controller according to the present disclosure.

The position information sensor 17 obtains position information (e.g., latitude and longitude) of the vehicle 10 at a predetermined cycle. The position information sensor 17 is, for example, a GPS (Global Positioning System) receiver, a wireless LAN communication unit, etc. The information obtained by the position information sensor 17 is recorded in, for example, the auxiliary storage unit 13 or the like, and transmitted to the center server 30.

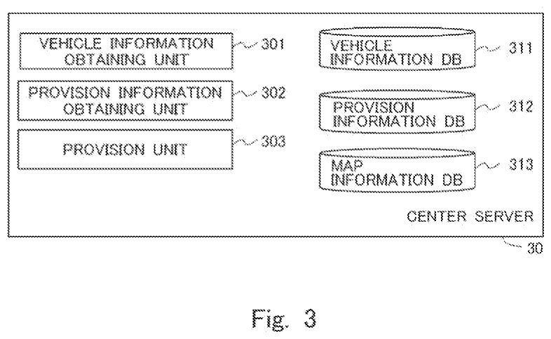

Then, the functions of the center server 30 will be described. FIG. 3 is a view illustrating by way of example a functional configuration of the center server 30. The center server 30 includes, as functional components, a vehicle information obtaining unit 301, a provision information obtaining unit 302, a provision unit 303, a vehicle information DB 311, a provision information DB 312, and a map information DB 313. The processor 31 of the center server 30 executes the processing of the vehicle information obtaining unit 301, the provision information obtaining unit 302, and the provision unit 303 by a computer program on the main storage unit 32. However, any of the individual functional components or a part of the processing thereof may be implemented by a hardware circuit.

The vehicle information DB 311, the provision information DB 312, and the map information DB 313 are constructed by a program of a database management system (DBMS) executed by the processor 31 that manages the data stored in the auxiliary storage unit 33. The vehicle information DB 311, the provision information DB 312, and the map information DB 313 are, for example, relational databases.

Here, note that any of the individual functional components of the center server 30 or a part of the processing thereof may be implemented by another or other computers connected to the network N1.

The vehicle information obtaining unit 301 obtains information about the vehicle 10 (hereinafter also referred to as vehicle information). The vehicle information is information used to present information corresponding to the destination to the user who is driving the vehicle 10. The vehicle information includes information about a vehicle ID that is an identifier unique to the vehicle 10, a current location of the vehicle 10, the destination of the vehicle 10, and the like. Upon receiving the vehicle information from the in-vehicle device 100, the vehicle information obtaining unit 301 stores the vehicle information in the vehicle information DB 311.

The provision information obtaining unit 302 obtains information corresponding to the destination of the user. For example, a recommended spot or a tourist guide map corresponding to a tourist site is obtained. In addition, for example, information about a parking fee corresponding to a parking lot, stores for which the parking fee is discounted, or the like is obtained. Further, for example, a menu corresponding to a restaurant is obtained. These pieces of information are obtained, for example, from a terminal managed by a local government that manages the tourist site, or from a terminal managed by an owner of a store, a facility, or the parking lot. The information corresponding to the destination of the user may have been obtained in advance by the provision information obtaining unit 302 and stored in the provision information DB 312, or may be obtained each time the vehicle information is obtained from the in-vehicle device 100, and stored in the vehicle information DB 311.

The provision unit 303 transmits information corresponding to the destination of the vehicle 10, i.e., the destination of the user, to the in-vehicle device 100. The provision unit 303 accesses the vehicle information DB 311, and transmits the information corresponding to the destination to the in-vehicle device 100 of the vehicle 10, in cases where the current location of the vehicle 10 matches the destination or in cases where the distance between the current location of the vehicle 10 and the destination becomes equal to or less than a predetermined distance. When route guidance is being executed in the vehicle 10, the provision unit 303 may generate a command to display the information corresponding to the destination of the user on the display 15 at the same time as the route guidance ends at the destination.

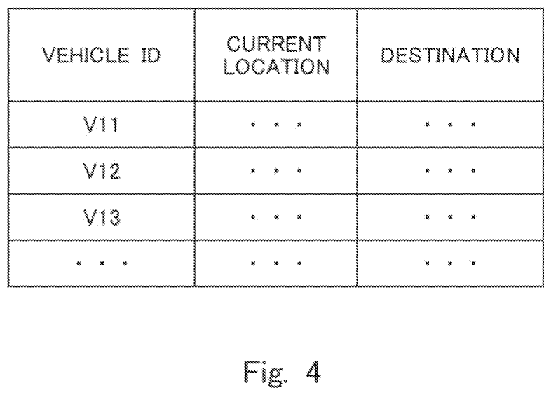

Here, the configuration of the vehicle information stored in the vehicle information DB 311 will be described based on FIG. 4. FIG. 4 is a view illustrating by way of example a table configuration of the vehicle information. A vehicle information table has fields for vehicle ID, current location, and destination. Identification information (vehicle ID) for identifying the vehicle 10 driven by the user is entered in the vehicle ID field. The vehicle ID has been assigned to each vehicle 10 in advance by the center server 30. Information about the current location of the vehicle 10 is entered in the current location field. The information on the current location of the vehicle 10 is position information detected by the position information sensor 17 of the in-vehicle device 100, and is provided from the in-vehicle device 100. Note that in the current location field, information on the current location of the user terminal 20 transmitted from the user terminal 20 may be entered.

In the destination field, information about the destination of the vehicle 10 is input. The information about the destination of the vehicle 10 is information entered or inputted by the user into the input unit 14 of the in-vehicle device 100, and is provided from the in-vehicle device 100. For example, the user enters or inputs a destination so as to use the navigation system. In the destination field, for example, information capable of identifying the location thereof such as coordinates, a name, an address or the like is entered.

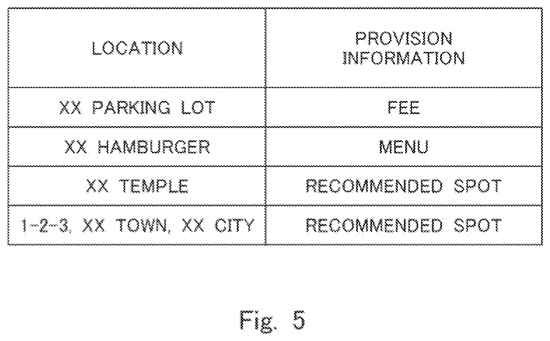

Next, the configuration of the provision information stored in the provision information DB 312 will be described based on FIG. 5. FIG. 5 is a view illustrating by way of example a table configuration of the provision information. The provision information is obtained from a server, a terminal, or the like of an administrator of a tourist site, a store, a parking lot, or the like. A provision information table has fields for location and provision information. In the location field, information about a location that can be a destination of the vehicle 10 is entered. In the location field, for example, information capable of identifying the location thereof such as coordinates, a name, an address or the like is entered.

In the provision information field, for example, information corresponding to the location entered in the place field is entered. For example, information indicating the location of a parking lot is entered in the location field, and information about the fee for the parking lot or information about stores or facilities that provide discount services for the fee for the parking lot is entered in the provision information field. The information about the stores or facilities includes, for example, coordinates, addresses, names, maps, or the like. In addition, for example, information about the location of a restaurant (e.g., XX Hamburger) is entered in the location field, and information about a menu of the restaurant is entered in the provision information field. Also, for example, information about the location of a tourist site (e.g., XX Temple) is entered in the location field, and information about a recommended spot in the tourist site or information about a tourist map is entered in the provision information field. The tourist map includes a description of each spot, a photo of each spot, or a route to take around the area.

In addition, a two-dimensional code for displaying the information corresponding to the destination may be entered in the provision information field. This two-dimensional code is, for example, a two-dimensional code that can be read by the input unit 24 (e.g., a camera) of the user terminal 20. In the user terminal 20 that has read the two-dimensional code, information corresponding to the two-dimensional code is displayed on the display 25. For example, in cases where the user needs to pay a fee at the destination, a two-dimensional code to display a payment screen or to make a payment may be entered in the provision information field. In addition, for example, a drive-through of a restaurant may be entered in the location field, and both information about a menu and a two-dimensional code to make a payment may be entered in the provision information field.

The map information DB 313 stores map information including map data and POI (POINT OF INTEREST) information such as characters and photographs that indicate the characteristics of each point on the map data. The map information DB 313 may be provided from another system connected to the network N1, for example, a GIS (Geographic Information System).

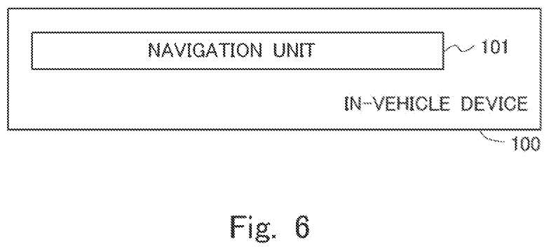

Next, the function of the in-vehicle device 100 of the vehicle 10 will be described. FIG. 6 is a view illustrating by way of example a functional configuration of the in-vehicle device 100. The in-vehicle device 100 includes a navigation unit 101 as a functional component. The processor 11 of the in-vehicle device 100 executes the processing of the navigation unit 101 by a computer program on the main storage unit 12. However, a part of the processing of the navigation unit 101 may be executed by a hardware circuit.

The navigation unit 101 displays a map of an area around the current location of the vehicle 10 based on the map information stored in the auxiliary memory unit 13. The map information stored in the auxiliary storage unit 13 is equivalent to the map information stored in the map information DB 313 of the center server 30. In addition, the navigation unit 101 generates a moving route of the vehicle 10 based on the current location obtained by the position information sensor 17 and the destination entered by the user via the input unit 14, and guides or provides the moving route to the user. Known techniques can be used to generate the moving route. For example, the navigation unit 101 displays the map and the moving route on the display 15, and provides voice guidance on the direction of movement of the vehicle 10.

Moreover, the navigation unit 101 transmits the current location and destination of the vehicle 10 to the center server 30 in association with the vehicle ID. Thereafter, the navigation unit 101 receives provision information corresponding to the destination from the center server 30. When the vehicle arrives at the destination, the navigation unit 101 switches an image to be displayed on the display 15 from an image for route guidance to an image based on the provision information.

For example, in cases where the destination is a drive-through of a restaurant, the navigation unit 101 will display a menu of the restaurant on the display 15 at the same time as the route guidance ends. This makes it easier for the user to place an order. Also, for example, in cases where the destination is a parking lot, the navigation unit 101 displays a charge or fee of the parking lot on the display 15 at the same time as the end of the route guidance. In addition, for example, in cases where the destination is a parking lot, the navigation unit 101 displays on the display 15 the name and the location of a store or facility that provides a discount service for the charge of the parking lot at the same time as the end of the route guidance. Moreover, for example, in cases where the destination is a tourist site, the navigation unit 101 may display the guidance of tourist spots at the same time as the end of the route guidance, or may display a map (or a tourist map) that facilitates going around the tourist site.

Here, note that in the above-mentioned example, the information corresponding to the destination is directly displayed on the display 15, but as an alternative method, a two-dimensional code for displaying the information corresponding to the destination on the display 25 of the user terminal 20 may be displayed on the display 15 of the in-vehicle device 100. In this case, the user may read the two-dimensional code with the input unit 24 (e.g., a camera) of the user terminal 20, so that information corresponding to the two-dimensional code may be displayed on the display 25 of the user terminal 20.

Further, in cases where the user needs to pay a fee at the destination, a two-dimensional code for displaying a payment screen or a two-dimensional code for making a payment may be displayed on the display 15. Then, the two-dimensional code may be read by a camera provided on the user terminal 20, and payment may be made based on the read information. For example, in cases where the destination is a parking lot, a two-dimensional code for paying a parking fee may be displayed on the display 15. In addition, for example, in cases where the destination is a gas station, a two-dimensional code for paying a gasoline charge may be displayed on the display 15. Also, for example, in cases where the destination is a drive-through of a restaurant, a two-dimensional code for paying a charge for food and drink may be displayed on the display 15 after a menu of the restaurant is displayed. Switching from displaying the menu to displaying of the two-dimensional code may be made, for example, when the user enters information into the input unit 14.

In addition, as another method, communication may be made between the in-vehicle device 100 and the user terminal 20, so that the provision information may be transmitted from the in-vehicle device 100 to the user terminal 20, and an image corresponding to the provision information may be displayed on the display 25 of the user terminal 20. Further, as an alternative method, the center server 30 may directly transmit the provision information to the user terminal 20, so that the display 25 of the user terminal 20 may display an image corresponding to the provision information.

The above-mentioned destination may not be a final destination but may be a stopover point. For example, in cases where there is another final destination and the user is stopping at a drive-through of a restaurant as a stopover point, the display of the display 15 may be switched from a menu of the restaurant to route guidance to the final destination when the user leaves the drive-through.

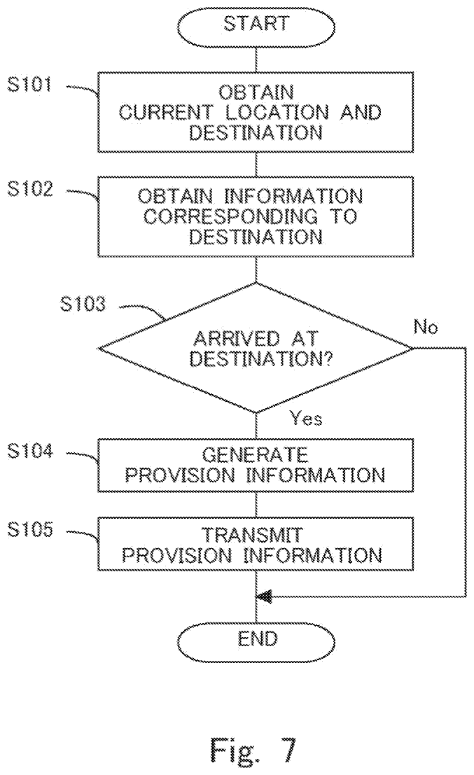

Next, provision processing in which the center server 30 transmits the provision information to the vehicle 10 will be described. FIG. 7 is a flowchart of the provision processing according to the present embodiment. The provision processing illustrated in FIG. 7 is repeatedly executed by the center server 30 for each vehicle 10 at predetermined time intervals. Here, note that the following description will be made on the assumption that necessary information is stored in the provision information DB 312.

In step S101, the vehicle information obtaining unit 301 obtains a current location of the vehicle 10 and a destination. The vehicle information obtaining unit 301 stores the current location and the destination periodically transmitted from the vehicle 10 in the vehicle information DB 311 in association with the vehicle ID. In step S101, the provision information obtaining unit 302 reads the current location of the vehicle 10 and the destination stored in the vehicle information DB 311. Note that, as another method, the processing in and after step S102 may be started when the current location and the destination are received from the vehicle 10.

In step S102, the provision information obtaining unit 302 obtains information corresponding to the destination from the provision information DB 312. The provision information obtaining unit 302 compares the destination transmitted from the vehicle 10 with the locations stored in the location field of the provision information DB 312, and extracts a matching location. Then, provision information stored in the provision information field of the same record as that location is obtained as information corresponding to the destination of the vehicle 10.

In step S103, the provision unit 303 determines whether or not the vehicle 10 has arrived at the destination. The provision unit 303 compares the current location stored in the vehicle information DB 311 with the destination, and determines that the vehicle 10 have arrived at the destination, when the current location matches the destination or when the destination is within a predetermined range from the current location. In other words, the predetermined distance is set so that the user can arrive at the destination without getting lost even after the route guidance in the vehicle 10 is completed. When an affirmative determination is made in step S103, the processing proceeds to step S104, whereas when a negative determination is made, this routine is ended.

In step S104, the provision unit 303 generates provision information. The provision unit 303 generates the provision information including a command to display the information obtained in step S102 on the display 15 of the vehicle 10. Then, in step S105, the provision unit 303 transmits the provision information to the vehicle 10.

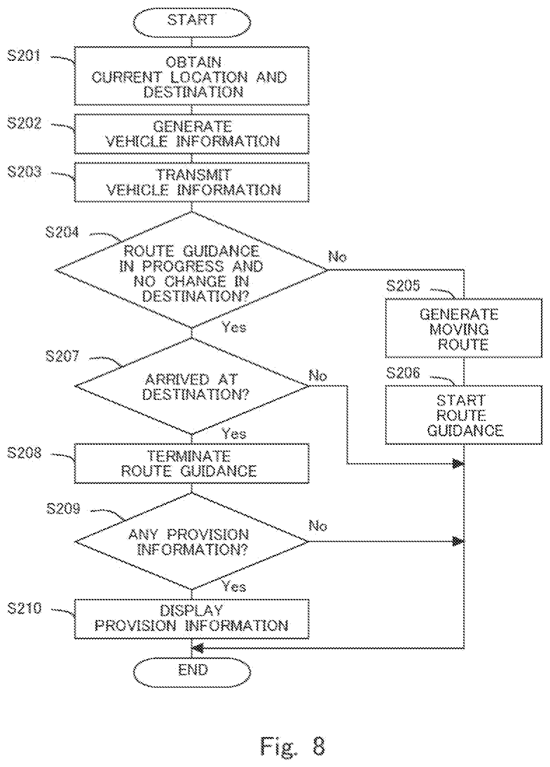

Next, the processing executed by the in-vehicle device 100 will be described. FIG. 8 is a flowchart of the processing executed by the in-vehicle device 100 according to the present embodiment. The processing illustrated in FIG. 8 is repeatedly executed by the in-vehicle device 100 at predetermined time intervals.

In step S201, the navigation unit 101 obtains a current location and a destination. The current location is detected by the position information sensor 17. In addition, the navigation unit 101 stores in the auxiliary memory section 13 the destination entered in the input unit 14 when the user uses the route guidance. In step S201, the navigation unit 101 reads the destination stored in the auxiliary storage unit 13.

Subsequently, in step S202, the navigation unit 101 generates vehicle information. The navigation unit 101 generates the vehicle information by associating the current location and the destination with the vehicle ID stored in the auxiliary storage unit 13. The vehicle ID is assigned in advance by the center server 30. In step S203, the navigation unit 101 transmits the vehicle information to the center server 30.

In step S204, the navigation unit 101 determines whether or not the route guidance is in progress and whether or not there is no change in the destination. In this step S204, it is determined whether or not it is necessary to generate a moving route. When an affirmative determination is made in step S204, the processing proceeds to step S207, and when a negative determination is made, the processing proceeds to step S205.

In step S205, the navigation unit 101 generates a moving route. The navigation unit 101 generates an optimal route from the current location to the destination. Known techniques can be used to generate the moving route. In step S206, the navigation unit 101 starts route guidance. For example, the navigation unit 101 displays the map and the moving route on the display 15, and provides voice guidance on the direction of movement of the vehicle 10.

On the other hand, in step S207, the navigation unit 101 determines whether or not the vehicle 10 has arrived at the destination. The navigation unit 101 determines that the vehicle 10 has arrived at the destination when the current location of the vehicle 10 matches the destination, or when the distance between the current location of the vehicle 10 and the destination is equal to or less than a predetermined distance. When an affirmative determination is made in step S207, the processing proceeds to step S208, whereas when a negative determination is made, this routine is ended. In step 3208, the navigation unit 101 terminates the route guidance.

In step 3209, the navigation unit 101 determines whether or not provision information has been received from the center server 30. When an affirmative determination is made in step 3209, the processing proceeds to step 3210, whereas when a negative determination is made, this routine is ended. That is, in cases where there is no information corresponding to the destination, this routine is ended with the end of the route guidance. On the other hand, in step 3210, the navigation unit 101 switches from the image for route guidance displayed on the display 15 to the image corresponding to the provision information. As a result, the image corresponding to the provision information is displayed on the display 15. The image corresponding to the provision information is displayed, for example, until an IG switch of the vehicle 10 is turned off or until a new destination is entered.

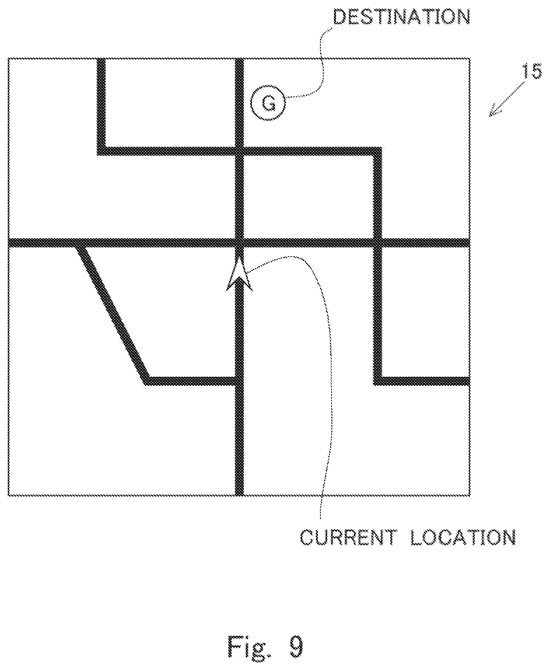

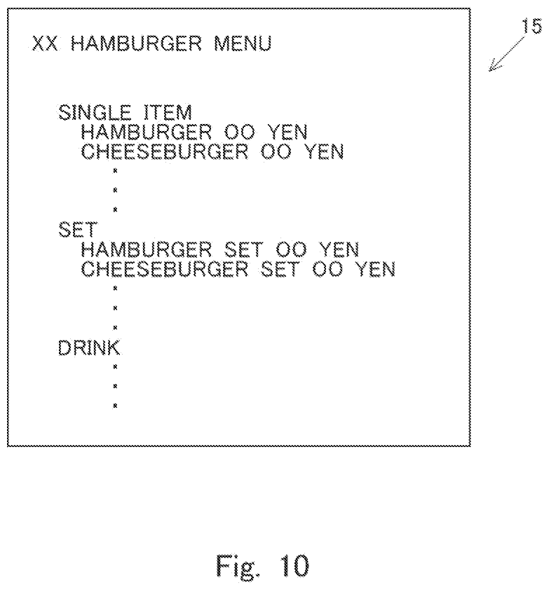

FIG. 9 is a diagram illustrating an example of an image displayed on the display 15 of the in-vehicle device 100 during route guidance. The image illustrated in FIG. 9 is displayed when the route guidance is started in the above-mentioned step 3206. In the route guidance, the current location of the vehicle 10 and the destination are displayed on the map. On the other hand, FIG. 10 is a diagram illustrating an example of an image displayed on the display 15 of the in-vehicle device 100 when the vehicle 10 arrives at the destination. FIG. 10 illustrates an example in which the destination is a restaurant and a menu of the restaurant is displayed. The image illustrated in FIG. 10 is displayed on the display 15 in the above-mentioned step 3210.

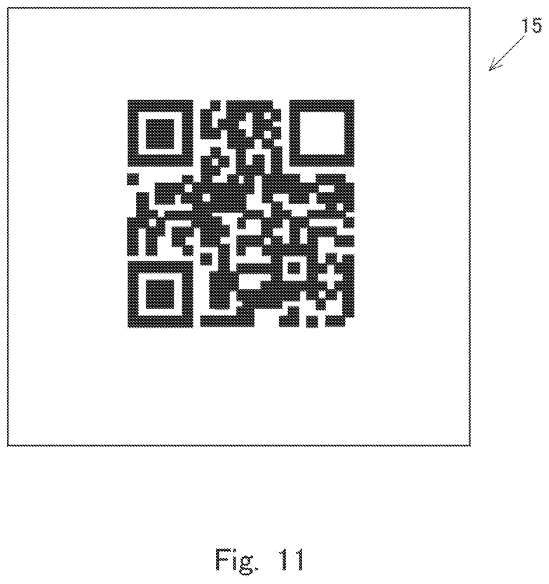

FIG. 11 is a diagram illustrating an example of another image displayed on the display 15 of the in-vehicle device 100 when the vehicle 10 arrives at the destination. FIG. 11 illustrates an example in which a two-dimensional code is displayed in order to display information about the destination on the display 25 of the user terminal 20. The user can display information corresponding to the destination on the display 25 of the user terminal 20 by reading the two-dimensional code with a camera provided on the user terminal 20. Thus, when the vehicle 10 arrives at the destination, the screen illustrated in FIG. 9 is switched to the screen illustrated in FIG. 10 or FIG. 11.

As described above, according to the present embodiment, when the vehicle arrives at the destination, the screen is switched to the screen corresponding to the destination, and information corresponding to the destination can be obtained. As a result, the convenience of the user can be improved.

### Modification of the First Embodiment

In the above-described embodiment, the center server 30 provides the vehicle 10 with information corresponding to the destination when the vehicle 10 arrives at the destination, but as an alternative method, the center server 30 may transmit information corresponding to the destination to the vehicle 10 immediately after obtaining the destination from the vehicle 10. In this case, the center server 30 does not need to determine whether or not the vehicle 10 has arrived at the destination. Therefore, it is not necessary for the vehicle information obtaining unit 301 to obtain the current location in step S101. In addition, the vehicle information generated in step S202 should include the vehicle ID and information about the destination. Also, the step S103 can be omitted. Further, the current location field of the vehicle information DB 311 can also be omitted.

### OTHER EMBODIMENTS

The above-described embodiment and its modification are merely examples, but the present disclosure can be implemented with appropriate modifications without departing from the spirit thereof.

The processing and/or means (devices, units, etc.) described in the present disclosure can be freely combined and implemented as long as no technical contradiction occurs.

The processing described as being performed by one device or unit may be shared and performed by a plurality of devices or units. Alternatively, the processing described as being performed by different devices or units may be performed by one device or unit. In a computer system, a hardware configuration (server configuration) for realizing each function thereof can be changed in a flexible manner. For example, the user terminal 20 may include a part of or all of the functions of the in-vehicle device 100. Also, for example, the in-vehicle device 100 may include a part of or all of the functions of the center server 30. For example, provision information may have been stored in advance in the auxiliary storage unit 13 of the in-vehicle device 100.

In addition, in the above-described embodiment and its modification, examples in which the in-vehicle device 100 provides route guidance when the user is moving in the vehicle 10 have been described, but as an alternative, the present invention can similarly be applied to a case in which the user terminal 20 provides route guidance when the user carrying the user terminal 20 moves on foot, by a train, by a bus, or by a ship. Also, the in-vehicle device 100 may provide route guidance to a destination, and the user terminal 20 may display information corresponding to the destination.

The present disclosure can also be realized by supplying to a computer a computer program in which the functions described in the above-described embodiment or its modification are implemented, and reading out and executing the program by means of one or more processors included in the computer. Such a computer program may be provided to the computer by a non-transitory computer readable storage medium that can be connected to a system bus of the computer, or may be provided to the computer via a network. The non-transitory computer readable storage medium includes, for example, any type of disk such as a magnetic disk (e.g., a floppy (registered trademark) disk, a hard disk drive (HDD), etc.), an optical disk (e.g., a CD-ROM, a DVD disk, a Blu-ray disk, etc.) or the like, a read-only memory (ROM), a random-access memory (RAM), an EPROM, an EEPROM, a magnetic card, a flash memory, an optical card, or any type of medium suitable for storing electronic commands or instructions.

What is claimed is:

1. An information processing apparatus including a controller configured to perform:
obtaining a current location of a user;
obtaining a destination of the user;
outputting guidance to the destination;
obtaining information corresponding to the destination;
determining, based on the destination and the current location, that the user has arrived at the destination; and
switching from outputting the guidance to the destination to outputting the information corresponding to the destination, when the user has arrived at the destination.

2. The information processing apparatus according to claim 1, wherein
the controller outputs, as the information corresponding to the destination, information about a service that will be provided to the user at the destination.

3. The information processing apparatus according to claim 1, wherein
in cases where a restaurant is present at the destination, the controller outputs a menu of the restaurant as the information corresponding to the destination.

4. The information processing apparatus according to claim 1, wherein
in cases where payment of a fee occurs at the destination, the controller outputs information about the fee as the information corresponding to the destination.

5. The information processing apparatus according to claim 4, wherein
in cases where the destination is a parking lot, the controller outputs information about a parking fee as the fee.

6. The information processing apparatus according to claim 4, wherein
the controller outputs, as the information corresponding to the destination, information about a store or a facility that offers a service for discounting the fee.

7. The information processing apparatus according to claim 1, wherein
in cases where the destination is a tourist site, the controller outputs a tourist guide associated with the tourist site as the information corresponding to the destination.

8. The information processing apparatus according to claim 1, wherein
in cases where the destination is a tourist site, the controller outputs a tourist route associated with the tourist site as the information corresponding to the destination.

9. The information processing apparatus according to claim 1, wherein
in cases where payment of a fee occurs at the destination, the controller outputs, as the information corresponding to the destination, a two-dimensional code for paying the fee at a portable terminal of the user.

10. The information processing apparatus according to claim 1, wherein
the controller outputs, as the information corresponding to the destination, a two-dimensional code for accessing an image corresponding to the destination.

11. An information processing method for causing a computer to perform;
obtaining a current location of a user;
obtaining a destination of the user;
outputting guidance to the destination;
obtaining information corresponding to the destination;
determining, based on the destination and the current location, that the user has arrived at the destination; and
switching from outputting the guidance to the destination to outputting the information corresponding to the destination, when the user has arrived at the destination.

12. The information processing method according to claim 11, wherein
the computer outputs, as the information corresponding to the destination, information about a service that will be provided to the user at the destination.

13. The information processing method according to claim 11, wherein
in cases where a restaurant is present at the destination, the computer outputs a menu of the restaurant as the information corresponding to the destination.

14. The information processing method according to claim 11, wherein
in cases where payment of a fee occurs at the destination, the computer outputs information about the fee as the information corresponding to the destination.

15. The information processing method according to claim 14, wherein
in cases where the destination is a parking lot, the computer outputs information about a parking fee as the fee.

16. The information processing method according to claim 11, wherein
in cases where the destination is a tourist site, the computer outputs a tourist guide associated with the tourist site as the information corresponding to the destination.

17. The information processing method according to claim 11, wherein
in cases where the destination is a tourist site, the computer outputs a tourist route associated with the tourist site as the information corresponding to the destination.

18. The information processing method according to claim 11, wherein
in cases where payment of a fee occurs at the destination, the computer outputs, as the information corresponding to the destination, a two-dimensional code for paying the fee at a portable terminal of the user.

19. The information processing method according to claim 11, wherein
the computer outputs, as the information corresponding to the destination, a two-dimensional code for accessing an image corresponding to the destination.

20. A non-transitory storage medium storing a program for causing a computer to execute the information processing method according to claim 11.
